(19) United States
(12) Patent Application Publication
(10) Pub. No.: US 2003/0191805 A1
(43) Pub. Date: Oct. 9, 2003

(54) Methods, apparatus, and systems for on-line seminars

(76) Inventors: William Brian Seymour, Merrimac, NH (US); Stephen W. Lang, Hollis, NH (US)

Correspondence Address: Finnegan, Henderson, Farabow,, Garrett & Dunner, L.L.P., 1300 I Street, N.W., Washington, DC, 20005-3315, US

(21) Appl. No.: 10/361,921

(22) Filed: Feb. 11, 2003

Related U.S. Application Data
(60) Provisional application No. 60/354,944, filed on Feb. 11, 2002.

(51) Int. Cl. G06F 15/16; G09G 5/00

(52) U.S. Cl. 709/204; 345/730; 709/203

(57) ABSTRACT

Methods, apparatus, and systems are provided for on-line seminars over a network. A client receives sets of program code that perform operations requested by a presenter. A stream is transmitted from a server to the client for the presentation. The server detects the operations requested by the presenter and pushes an event that indicates the requested operation into the stream. The client receives the event, selects a set of program codes based on information in the pushed event, and executes the selected set of program code in synchronization with the at least one stream.

### CROSS REFERENCE TO RELATED APPLICATIONS

This application claims the benefit of U.S. Provisional Patent Application No. 60/354,944, entitled “METHODS, APPARATUS, AND SYSTEMS FOR ON-LINE SEMINARS,” filed on Feb. 11, 2002, the disclosure of which is expressly incorporated herein by reference in its entirety.

### FIELD OF THE INVENTION

The present invention relates to electronic learning and, more particularly, it relates to presentations or seminars provided over a network.

### BACKGROUND OF THE INVENTION

Delivering information, such as technical information, quickly and cost-effectively to a worldwide audience is a challenge faced by many organizations. Typically, an organization provides on-site seminars and field training programs to deliver information. For example, an organization may send a group of instructors around various sites to conduct training.

Unfortunately, training with on-site seminars and field programs is costly and inefficient. On-site seminars and field programs require extensive planning. Training materials for these programs often become obsolete in a short period of time. In addition, these seminars and programs may occur at inconvenient times for both the instructors and persons attending the training session.

On-line training, such as web broadcasts, has become a popular alternative to on-site seminars and field programs. Typically, on-line training involves users connecting to a network, such as the Internet; downloading one or more files; and executing an application at a prescribed time.

However, known on-line training products have several deficiencies. Users are often restricted to low bandwidth connections to the network, such as a dial-up modem connection. The files for the training may require a large amount of storage space and time to download. During an on-line training program, users often lose their place in the training relative to other users or the instructor. For example, a user may forget to proceed to a particular slide during the training session. Thus, users often are unable to participate in the training in real-time and the impact and retention of the training may be reduced.

It is therefore desired to provide methods, apparatus, and systems that address the above and other shortcomings of the prior art.

### SUMMARY OF THE INVENTION

In accordance with the invention, a method of synchronizing progress of a presentation running between a server and a client is provided, wherein the server transmits at least one stream for the presentation. The method comprises: identifying an event that is pushed from the server in response to an operation requested by a presenter during the presentation; interpreting the event at the client to determine a set of program code called by the event, wherein the set of program code performs the operation requested by the presenter; and executing the called set of program code in synchronization with the at least one stream.

In accordance with another aspect of the invention, a method of synchronizing progress of a presentation running between a server and a client, comprises: sending to the client sets of program code that perform operations requested by a presenter; transmitting at least one stream to the client for the presentation; detecting at the server at least one of the operations requested by the presenter; pushing from the server into the at least one stream an event that indicates the requested operation; selecting one of the sets of program codes based on information in the pushed event, wherein selected set of program code performs the requested operation; and executing the selected set of program code in synchronization with the at least one stream.

In accordance with yet another aspect of the invention, a system for providing a presentation comprises a first processor for encoding content for the presentation into at least one stream, detecting an operation requested by the at least one presenter, and inserting an event into the at least one stream indicating the requested operation and a second processor for transmitting the at least one stream to a client and pushing the event in the at least one stream to the client.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and together with the description, serve to explain the principles of the invention.

In the Figures:

FIG. 1 illustrates an exemplary system, in accordance with the principles of the present invention;

FIG. 2 illustrates an exemplary presenter segment, in accordance with the principles of the present invention;

FIG. 3 illustrates an exemplary server segment, in accordance with the principles of the present invention;

FIG. 4 illustrates an exemplary remote segment, in accordance with the principles of the present invention;

FIG. 5 illustrates an exemplary user segment, in accordance with the principles of the present invention; and

FIG. 6 illustrates an exemplary process for providing a presentation, in accordance with the principles of the present invention.

### DESCRIPTION OF THE EMBODIMENTS

Methods, apparatus, and systems are provided for on-line seminars or presentations over a network, such as the Internet. One or more presenters provide the content for the presentation. A moderator controls flow or progress of the presentation based on the content provided by the one or more presenters. Users may listen and/or watch the presentation content over the network either live with the presenters or on-demand based on an archived version of the presentation.

For example, one or more presenters may give a presentation using a browser to provide audio and visual content. The content for the presentation is created and gathered using known input devices, such as a video camera and microphone, or known applications for creating content, such as PowerPoint by the Microsoft Corporation. In addition, during the presentation, a presenter may perform or request various operations, such as change slides, move a pointer, conduct polls, and review questions.

A moderator receives the content from the presenters and controls various aspects of the presentation. For example, the moderator may determine when portions of the presentation's content are available for retrieval by the users. When a plurality of presenters is participating in the presentation, the moderator may select which of the presenters that will provide the content for the presentation at a particular time. The moderator may also select various formats and protocols for providing the presentation content. The moderator then encodes the audio and/or visual content for the presentation, determines control information, such as events indicating the various operations requested by the presenters, and provides the encoded content and control information to one or more servers.

The one or more servers deliver the presentation content and control information to the users. For example, a web server may be used to provide one or more web pages for the presentation to the users. A streaming server may also be used to deliver audio or video content using a real-time multimedia protocol. Furthermore, the one or more servers may send control information by pushing various events, for example, in the audio stream to the users. The events include information that indicates the various operations, such as slide changes or pointer moves, requested by the presenters.

The users may also use a browser to connect to the one or more servers and receive the audio and/or visual content of the presentation. In addition, when control information, such as an event, has been pushed from the servers, the user's browser may be used to call and execute a set of program code, such as a JavaScript. Since the event is pushed within a stream of the presentation, the set of program code may be executed in synchronization with the stream to perform the operation requested by the presenters. Accordingly, the users may then, for example, easily follow the presentation in synchrony with the presentation when the various operations are performed or requested by the presenters.

Reference will now be made in detail to embodiments of the invention, an example of which is illustrated in the accompanying drawings. Wherever possible, the same reference numbers will be used throughout the drawings to refer to the same or like parts.

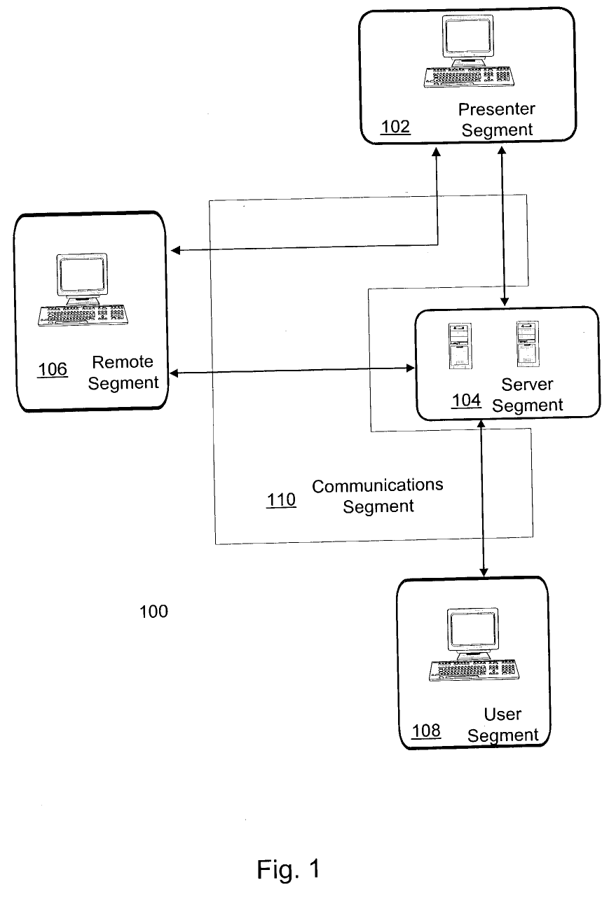

FIG. 1 illustrates an exemplary system, in accordance with methods, apparatus, and systems consistent with the principles of the present invention. As shown, a seminar system 100 may comprise a presenter segment 102, a server segment 104, a remote segment 106, a user segment 108, and a communications segment 110.

Presenter segment 102 provides an interface between a presenter and system 100 to provide content for the presentation or seminar. Presenter segment 102 is implemented using one or more general purpose computers interfacing with communications segment 110. In addition, presenter segment 102 may be equipped with various peripheral devices, such as a video camera, microphone, keyboard, mouse, or display to record content for the presentation or seminar. Accordingly, presenter segment 102 may provide content for the presentation or seminar in a variety of forms, such as video, audio, images, etc. Although seminar system 100 is shown with one presenter segment, system 100 may also include a plurality of presenter segments. Furthermore, a single presenter segment may accommodate multiple presenters.

Server segment 104 provides mediated connections between user segment 108 and remote segment 106. Server segment 104 also provides the content and control information for the seminar or presentation to user segment 108. Server segment 104 may include one or more servers interfacing with communications segment 110. In addition, server segment 104 may include other known types of network equipment, such as switches, routers, firewalls, etc.

Remote segment 106 captures the content from presenter segment 102 and provides control information for the seminar or presentation. In one embodiment, remote segment 106 may provide an interface to allow a moderator to control the flow and operation of the seminar or presentation. Remote segment 106 is implemented using one or more general purpose computers interfacing with communications segment 110. Although remote segment 106 is shown as a separate computer from server segment 104 and presenter segment 102, remote segment 106 may be integrated into the same computer as either server segment 104 or presenter segment 102.

User segment 108 provides an interface for a user to participate in the seminar or presentation. User segment 108 is implemented using one or more general purpose personal computers interfacing with communications segment 110. Alternatively, user segment 108 may be implemented on other devices that are capable of accessing communications segment 110, such as a mobile telephone or a personal digital assistant. Although seminar system 100 is shown with a single user segment, system 100 may accommodate any number of user segments. Furthermore, an individual user segment 108 may accommodate any number of users.

Communications segment 110 provides communications for the seminar or presentation between the various segments of seminar system 100. For example, communications segment 110 may include one or more networks, such as the Internet. Communications segment 110 is implemented using known types of network equipment to support a variety of protocols, such as Internet Protocol (“IP”), Hypertext Transport Protocol (“http”), and Real Time Streaming Protocol (“RTSP”). RFC-2326, H. Schulzrinne et al., The Internet Society (1998), titled “Real Time Streaming Protocol (RTSP),” describes, inter alia, RTSP and is incorporated herein by reference in its entirety, etc. In addition, communications segment 110 may include respective access links, such as dedicated lines, or dialup lines, for presenter segment 102, server segment 104, remote segment 106, and user segment 108.

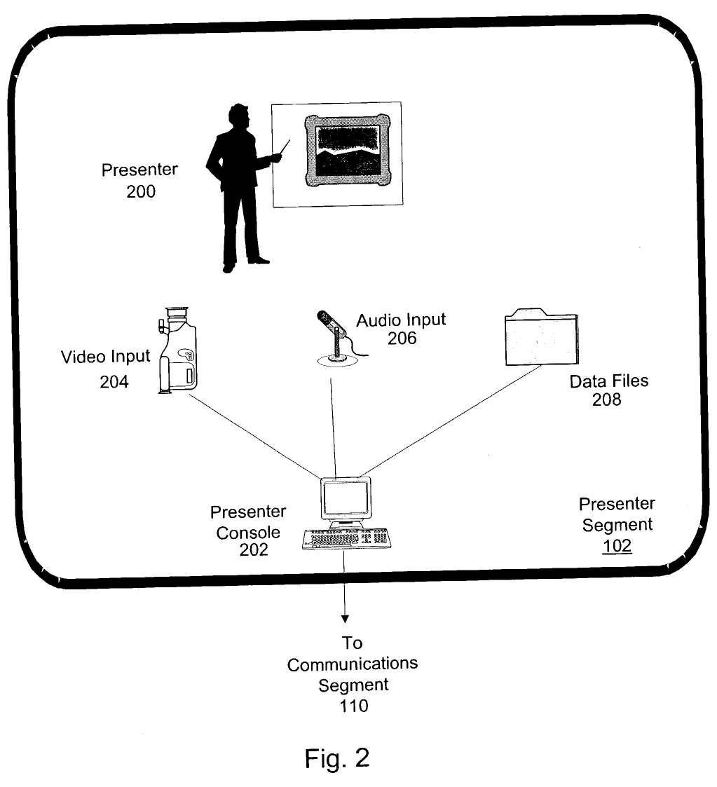

FIG. 2 illustrates a more detailed depiction of presenter segment 102, in accordance with the principles of the present invention. As shown, a presenter 200 provides content for the presentation or seminar to a presenter console 202. Presenter console 202 runs on presenter segment 102 and is implemented using a browser, such as Netscape Navigator or Internet Explorer.

In one embodiment, presenter console 102 operates using Java program code, such as JavaScript and Java applets. Presenter console 202 may operate based on information locally stored on presenter segment 102 or may operate based on information served from server segment 104 to avoid the installation of one or more files on presenter segment 102.

Presenter console 202 is configured to receive content in various forms, such as through a video input 204, an audio input 206, or in the form of data files 208. Upon receiving the content, presenter console 202 then distributes the content via communications segment 110. For example, presenter 200 may use presenter console 202 to distribute the content based on whether it should be streamed. In particular, presenter console 202 may distribute content that is not intended for streaming, such as content in data files 208, to server segment 104. Server segment 104 may then store this content until remote segment 106 releases it to user segment 108. Alternatively, server segment 104 may also provide this content to user segment 108 upon request. Presenter console 202 may use known protocols, such as Transport Control Protocol (“TCP”) or File Transfer Protocol (“FTP”) to distribute content to server segment 104.

Presenter console 202 may also distribute content to remote segment 106 that is intended for streaming, such as content from video input 204 and audio input 206. In order to distribute this content to remote segment 106, presenter console 102 may use an embedded applet, which transmits information to remote segment 106 using HTTP “POST” messages and whose class files are obtained in response to HTTP “GET” messages from remote segment 106.

In addition to the content, during a seminar or presentation, presenter 200 may request or perform various operations that assist users in following the presentation or seminar using presenter console 202. These operations are then propagated from presenter console 202 through remote segment 106 and server segment 104 to user segment 108. The operations propagated to user segment 108 may include, for example, operations related to manipulating images, such as slides, moving a pointer, conducting a poll from users attending the seminar or presentation, switching between live versus recorded content, or parsing questions from users. However, any type of action that assists the user in following a presentation or seminar may be include an operation that is propagated by presenter console 202.

As an example, presenter console 202 may detect the location on a slide where presenter 200 is pointing through the use of layers, the known “<DIV>” tag, and manipulating inline style properties. Presenter console 202 may then execute JavaScript code to provide the location of the pointer to remote segment 106. As another example, presenter 200 may advance to a slide in order to highlight information on that slide. The slide being pointed may further contain certain Hypertext Markup Language (“HTML”) statements and JavaScript code to indicate where presenter 200 clicked on the slide. As yet another example, a slide may contain script that alerts the parent frame to the location of a pointer graphic and supplies the offset of the pointer tip relative to the origin of the pointer graphic.

Upon detecting an operation, presenter console 202 then transmits information about the operation to remote segment 106 using, for example, HTTP messages, UDP, or TCP. In particular, presenter console 102 may use a Java applet to open a connection through communications segment 110 to remote segment 106. Presenter console 102 may then execute a PerlScript to send User Datagram Protocol (“UDP”) packets to remote segment 106. Presenter console may also use HTTP to communicate with remote segment 106, for example, to minimize problems with any firewalls that may be between presenter segment 102 and remote segment 106.

Presenter console 202 may also provide other various operations or functions to presenter 200 to assist in conducting the presentation or seminar. For example, presenter console 202 may support various web pages with frames that include one or more Common Gateway Interface (“CGI”) scripts. In one embodiment, presenter console 202 may include CGIs for: checking a database to see if a user is registered and checking the state of the seminar; maintaining a list of users actively participating in the presentation or seminar; requesting a pop-up question-review window at user segment 108; requesting a window that pops-up at user segment 108 with a form in which a poll question is provided and the user is asked to respond; and requesting a poll results review window from remote segment 106 or server segment 104. Upon executing the CGIs for these operations, presenter console 102 may initiate various calls, such as JavaScript calls, in remote segment 106. In response, remote segment 106 may then send corresponding events to server segment 104, which are then pushed to user segment 104.

When there is a plurality of presenters, a moderator may be present at remote segment 106 to mediate which presenter provides content for the presentation or seminar. Since presenter segment 102 may be remote from the moderator, presenter console 202 may provide an indication, such as a colored indicator displayed on a web page in presenter console 202, to notify presenter 200 when he is currently selected by the moderator at remote segment 106.

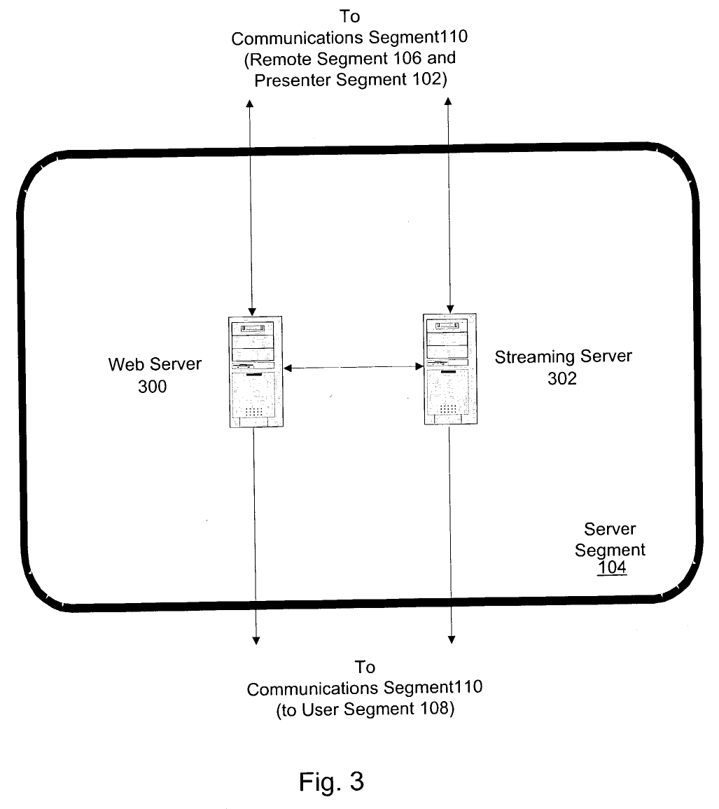

FIG. 3 illustrates server segment 104, in accordance with methods, apparatus, and systems consistent with the principles of the present invention. As shown, server segment 104 may include one or more servers, such as a web server 300 and a streaming server 302.

Web server 300 is implemented using known equipment that supports, for example, HTTP and HTML. Web server 300 may contain information that is common to multiple presentations. For example, web server 300 may contain: an archive template that may be used to build an archive from a completed presentation or seminar. Web server 300 may also contain a template for tags corresponding to typical tools or features used to control a presentation or seminar. In addition, web server 300 may contain multiple versions of templates and automatically update a template when a new version is installed. Web server 300 may also contain customer-specific templates. The customer templates may be used to build formatted presentations or seminars for a particular customer. Web server 300 may also contain: HTML and image files that are common to particular customers or sessions; various CGI scripts; and the various files that are used by the CGI scripts as templates for building pages for a presentation.

In order to reduce the bandwidth requirement of user segment 108 during the presentation or seminar, web server 300 may optionally provide a package of files that are available for download to user segment 104 prior to the presentation. The download package may include a folder of HTML and graphics files. For example, web server 300 may contain information that is unique to a particular presentation or seminar. This information may be stored on web server 300 based on a customer identifier and a session identifier. In one embodiment, information that is unique to a particular presentation or seminar may include: a slide list indicating the URLs of each slide; a database file that includes key-value pairs used by various database applications; a database lock file; a package of files that are to be downloaded to user segment 108; and files that are to be made available from web server 300 via HTTP.

Moreover, web server 300 may provide: a directory where archived versions of a presentation or seminar are stored; a directory where download packages may be stored; a directory where download packages are available via FTP; various files having to do with registration by the users, presenters, and moderator; and files for checking the multimedia capability of user segment 108. Although FIG. 3 shows a single web server, server segment 104 may include any number of web servers.

The seminar may be archived based on the files prepared and created during the live presentation. The archived version may be served from server segment 104. For example, audio for an archived seminar may be streamed from server segment 104 to user segment 108 from a file created during the live presentation. In addition, a transcript file may be viewed in a pop-up window at user segment 102. The pop-up window may display portions of the transcript file that correspond to a particular time during the presentation. The timing that the portions of the transcript file are displayed may also be based on events pushed from the server segment 104 to user segment 108.

For archived presentations and seminars, in one embodiment, server segment 104 may provide: files that indicate whether the archive includes audio or no audio; files for sourcing web pages for the archive; files that provide controls for the archive, such as a button that opens window for a transcript of the archive; files, such as JPEG images, for the archive; files displaying the slide; files that contain a URL for the audio file of the archive; and files providing a transcript of the archive. In addition, the transcript files may contain control information indicating, for example, the beginning of text corresponding to each slide.

Server segment 104 may include a copy of the JavaScript file that was created during the live seminar and the session-specific information, such as the slide list. In addition, server segment 104 may include a timeline file that declares and initializes an array of called “times” to maintain operations of the presentation or seminar in synchrony with, for example, the audio from the live presentation. The timeline file also allows a user to skip around within the archive while maintaining the synchronization of events during the live presentation.

Streaming server 302 provides data, such as audio or video data, in a stream to user segment 108. For example, in one embodiment, streaming server 302 is implemented as a RealServer by Real Networks, Inc. However, other types of streaming servers are consistent with the principles of the present invention. Although FIG. 3 shows streaming server 302 as a single computer, server segment 104 may include any number of streaming servers. Server segment 104 may also include other servers for authentication, database access, or other types of applications.

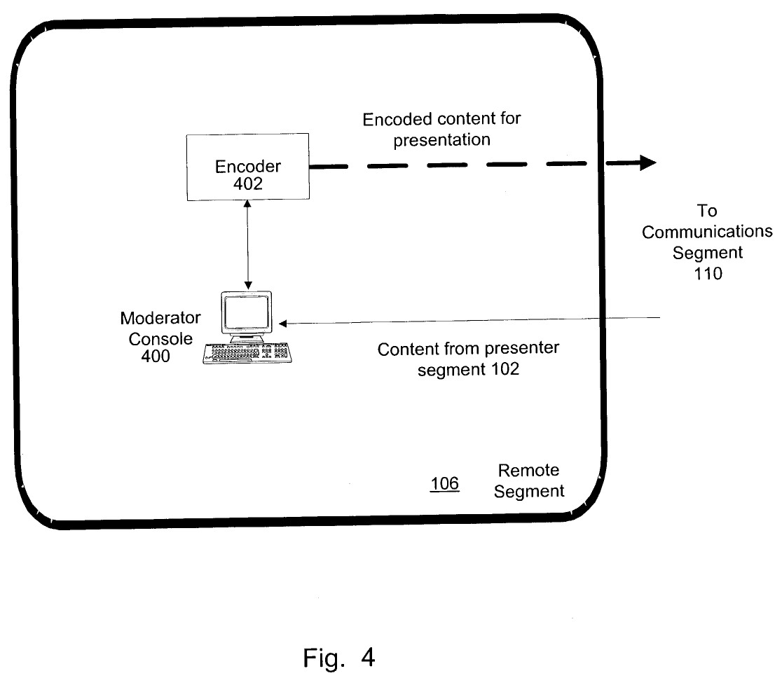

FIG. 4 illustrates a more detailed depiction of remote segment 106, in accordance with the principles of the present invention. As shown, a moderator console 400 and an encoder 402 run on remote segment 106.

Moderator console 400 is implemented using a browser, such as Netscape Navigator or Internet Explorer. Moderator console 400 operates based on similar files provided to user console 1 12. However, moderator console 400 is provided modified versions of several of the files to provide moderator-specific functionality.

In order to begin a presentation or seminar, a moderator (not shown) displays a login page at moderator console 400. Upon receiving the login information, one embodiment of moderator console 400 may enter the information into a cookie. Since the presenter has a unique user-id, moderator console 400 uses the cookie to read hidden fields for the presentation or seminar. In addition, several of the fields may be pre-filled. For example, fields specifying a session identifier and an audio or video server may be pre-filled based on information provided in the cookie.

Moderator console 400 also includes CGIs to server segment 104 to build various web pages for the moderator. For example, moderator console 400 may include a CGI to retrieve information, such as a slide list and a control script, for the presentation or seminar. In the event that the presenter 200 changes the slide list or control list, then moderator console 400 may generate JavaScript program code to accommodate the requested changes.

Moderator console 400 also includes CGIs for: handling user questions; detecting when the presenter requests to change the state of the seminar; and tracking the number of active users, for example, based on a periodic “heartbeat” signal from user segment 108.

As noted, remote segment 106 also includes encoder 402, which in one embodiment is based on RealProducer 8.5 from Real Networks, Inc., to produce a stream for content distributed from presenter segment 102. In one embodiment, encoder 402 encodes the content, such as audio or video, based on RTSP and provides the encoded content to server segment 104. In addition, in response to the operations detected by presenter segment 102, encoder may also embed control information in the form of event markers, such as Real Events (also known as “hurl”), within the stream. Encoder 402 sends its output to streaming server 302 for dissemination to user segment 108. In one embodiment, encoder 402 runs based on an HTML file that contains an embedded RealProducer object and Perl script.

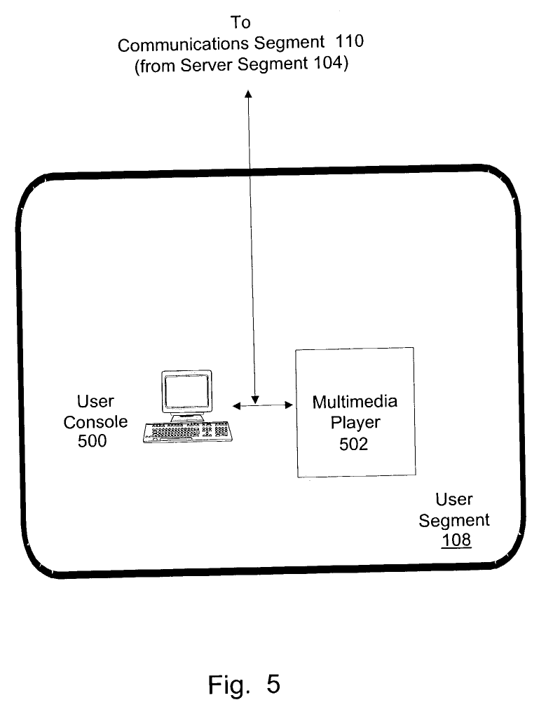

FIG. 5 illustrates a more detailed depiction of user segment 108, in accordance with the principles of the present invention. As shown, a user console 500 and multimedia player 502 runs on user segment 108. User console 500 is implemented using a browser, such as Netscape Navigator or Internet Explorer.

Prior to a presentation or seminar, user console 500 may optionally receive a download package from server segment 104. In one embodiment, user console 500 is restricted from obtaining the download package until an authorization is received from remote segment 106. The download package may include several HTML files to build various web pages for the presentation or seminar, such as presentation slides.

User console 500 displays various web pages with frames for the presentation or seminar. For example, user console 500 may display one or more web pages, that include: a form requesting information, such as a user-id, from the user; a frame for displaying controls for slide navigation, and audio or video related controls; a frame for displaying graphics, such as slides; and a page for displaying a pop-up window for polls requested by presenter 200.

User console 500 may execute one or more CGIs for handling user questions, and tracking when the user is actively participating in the presentation or seminar based on a periodic “hearbeat” signal that is sent to server segment 104. User console 500 also operates based on a JavaScript file and a meta-file to allow execution of any embedded applications. For example, multimedia player 502 may execute an embedded application, such as RealPlayer by Real Networks, Inc. or Media Player by Microsoft.

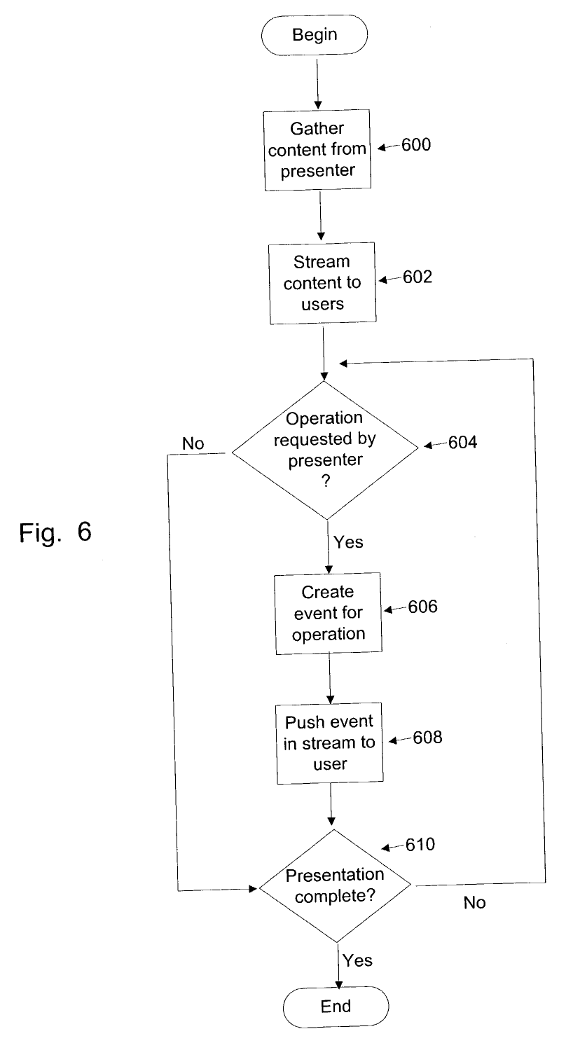

FIG. 6 illustrates an exemplary process for providing a presentation, in accordance with the principles of the present invention. In step 600, presenter 200 gathers content for the presentation or seminar. Presenter 200 uses presenter segment 102 to gather content, such as audio, video, and graphics. In addition, presenter 200 may create a download package that includes some, most, or all of the graphics and other files that will be used in the presentation. Presenter 200 then provides the content to remote segment 106 and server segment 104.

In one embodiment, presenter segment 200 distributes content that is not intended for streaming, such as static images or slides, to server segment 104. Presenter segment 200 distributes content that is intended for streaming, such as audio or video data, to remote segment 106. Remote segment 106 determines when the content may be transmitted to user segment 104. For example, in order to begin a presentation, presenter 200, the moderator, and the users may be required to login with web server 300 using a login web page.

Upon successful login by one or more parties, server segment 104 may allow at least portions of the content for the presentation to be available. For example, upon successful login by presenter 200 and the moderator at remote segment 106, the moderator may then send a message to server segment 104. Server segment 104 may then in turn send a message, such as an e-mail, to user segment 108. The message may include, for example, one or more URLs for portions of the content for the presentation and information identifying streaming server 302, such as an IP address. User segment 108 may then download the content stored in web server 300 and establish communications with streaming server 302.

In step 602, remote segment 106 begins streaming the content to user segment 108 via server segment 104. In particular, remote segment 106 receives the content from presenter segment 102. Encoder 402 encodes selected content, such as the audio or video, into a stream and 106 then transmits the stream to streaming server 302. Streaming server 302 may then stream content for the presentation to user console 500 and multimedia player 502. The stream between streaming server 302 and multimedia player 502 may comprises one or more channels, such as a channel for carrying data and a channel for carrying control events (i.e., a control channel). The control channel may include various events, such as hurl, which synchronize various aspects of the presentation, such as slide transitions, or embedded applications supported by user console 500, and events corresponding to operations performed by presenter 200.

User console 500 displays the presentation based on the information served from web server 300 and the stream from streaming server 302. For example, as noted above, user console 500 may include a web page with a presentation window that displays graphics for the presentation. In addition, user console 500 may use multimedia player 502 to play the audio and/or video data in the stream from streaming server 302. User console 500 uses the events in the control channel of the stream from streaming server 302 to synchronize these aspects of the presentation.

In step 604, remote segment 106 determines whether the presentation includes an operation requested by presenter 200. If remote segment does not detect a requested operation, then processing flows to step 610. If remote segment determines that an operation was requested, then processing flows to step 606.

For example, presenter console 200 may detect whether presenter 200 has moved a pointer, navigated to a particular slide, requested a new stream at a different URL, requested a poll from the users, or requested questions from the users. In one embodiment, presenter 200 provides information about the operation requested by presenter 200 using one or more Java applets and sending, for example, HTTP messages, UDP packets, or TCP packets to remote segment 106.

Moderator console 400 of remote segment 106 may then detect that information about the operations has been received and determine a corresponding call for a set of program code that is executable by user segment 108. For example, moderator console 400 may operate in conjunction with encoder 402 to determine a particular JavaScript call that corresponds to the operation. In addition, moderator console 400 and encoder 402 may parse the information about the operations from presenter segment 102 to determine one or more parameters, such as a slide number or pointer coordinates, for executing the set of program code. Encoder 402 then creates an event, such as text string, and sends it to streaming server 302 using, for example, a TCP connection.

In step 606, remote segment 106 creates an event in response to the operation requested (or performed) presenter 200. In particular, moderator console 400 receives the information indicating the operation and provides it to encoder 402. Encoder 402 then creates an event for the operation and sends the event to streaming server 302. In one embodiment, encoder 402 creates an event based on RTSP.

For example, encoder 402 may create a hurl that is compatible with products by Real Networks. In particular, the event may be encoded as a string, such as “&&control&&javascript:wp(‘hide’,2).” The portion of the event to the left of the colon indicates that the event is, for example, a JavaScript call. The portion after the colon (i.e., “wp”) identifies the particular set of program code that is called by the event.

In step 608, streaming server 302 pushes the event to user segment 108. In particular, streaming server 302 pushes the event to user segment 108 by inserting the event into the control channel of the stream. In one embodiment, streaming server 302 pushes the event into the control channel of a RTSP audio stream to multimedia player 502.

Multimedia player 502 in user segment 108 then interprets the event. As noted, the event may use a known format, such as a hurl event for a Real Player, and include a call for executing a set of program code, such as JavaScript. Accordingly, multimedia player 502 may, for example, parse the event to determine whether it relates to progress of the presentation, or includes a call to a set of program code, such as JavaScript, that corresponds to an operation requested by presenter 200. As noted above, in one embodiment, multimedia player 502 may identify that the event calls a set of program code when the event includes the string “%%control%%javascript.” In response, multimedia player 502 may then notify user console 500 to call the identified set of program code.

User console 500 may include sets of program code, such as JavaScript, for displaying movement of a pointer, navigating to a slide specified in the event, changing the stream received by multimedia player 502, and displaying a pop-up window in response to poll conducted by presenter 200. Other sets of program code for other operations are also consistent with the principles of the present invention. User console 500 may store the sets of local program code, for example, based on downloading files from web server 300 or may dynamically load the sets of program code from web server 300. User console 500 then executes the called set of program code based on the parameters indicated in the event, such as “(‘hide’,2). ”

Accordingly, user console 500 may perform the operations requested by presenter 200 in synchronization with the stream. For example, user console 500 may display slide transitions in synchronization with a particular point in an audio stream. Therefore, users at user segment 108 may easily follow the presentation or seminar.

In step 610, user console 500 determines whether the presentation or seminar is complete. User console 500 may determine whether the presentation is complete based, for example, on the slide list or from an event pushed into the stream between user segment 108 and server segment 104. If the presentation is not complete, then processing repeats at step 604. If the presentation is complete, then processing ends.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of synchronizing progress of a presentation running between a server and a client, wherein the server transmits at least one stream for the presentation, said method comprising:
identifying an event that is pushed from the server in response to an operation requested by a presenter during the presentation;
interpreting the event at the client to determine a set of program code called by the event, wherein the set of program code performs the operation requested by the presenter; and
executing the called set of program code in synchronization with the at least one stream.

2. The method of claim 1, wherein identifying the event that is pushed from the server comprises identifying the event in the at least one stream.

3. The method claim 2, wherein identifying the event in the at least one stream comprises identifying the event in a channel of the at least one stream.

4. The method of claim 2, wherein identifying the event in the at least one stream comprises identifying the event in a stream of audio data generated by the presenter.

5. The method of claim 1, wherein interpreting the event at the client to determine the set of program code comprises:
determining when the event includes a javascript call; and
identifying a set of parameters in the javascript call.

6. The method of claim 5, wherein executing the called set of program code comprises executing the javascript call at the client based on the identified set of parameters.

7. The method of claim 1, wherein executing the called set of program code comprises displaying movement of a first pointer at the client in synchronization with movement of a second pointer by the presenter.

8. The method of claim 1, wherein executing the called set of program code comprises selecting a graphic requested by the presenter in synchronization with the at least one stream.

9. The method of claim 1, wherein executing the called set of program code comprises playing at least one additional stream at the client.

10. The method of claim 1, wherein executing the called set of program code comprises displaying a window at the client.

11. A method of synchronizing progress of a presentation running between a server and a client, said method comprising:
sending to the client sets of program code that perform operations requested by a presenter;
transmitting at least one stream to the client for the presentation;
detecting at the server at least one of the operations requested by the presenter;
pushing from the server into the at least one stream an event that indicates the requested operation;
selecting one of the sets of program codes based on information in the pushed event, wherein selected set of program code performs the requested operation; and
executing the selected set of program code in synchronization with the at least one stream.

12. The method of claim 11, wherein transmitting the at least one stream comprises transmitting a stream of audio data generated by the presenter.

13. The method of claim 11, wherein detecting the operation requested by the presenter comprises detecting movement of a pointer by the presenter.

14. The method of claim 11, detecting the operation requested by the presenter comprises determining a graphic requested by the presenter.

15. A system for providing a presentation, comprising:
a first processor for encoding content for the presentation into at least one stream, detecting an operation requested by the at least one presenter, and inserting an event into the at least one stream indicating the requested operation; and
a second processor for transmitting the at least one stream to a client and pushing the event in the at least one stream to the client.

16. The system of claim 15, wherein the second processor encodes audio information into the at least one stream.

17. The system of claim 15, wherein the second processor detects when the at least one presenter moves a pointer.

18. The system of claim 15, wherein the second processor detects when the at least one presenter selects a graphic of the presentation.

19. The system of claim 15, wherein the second processor detects when the at least one presenter requests information from a user participating in the presentation.

20. The system of claim 15, wherein the second processor inserts a javascript call into the event based on the operation requested by the at least one presenter.

21. The system of claim 15, further comprising:
a third processor for storing a set of files that include at least a portion of the content for the presentation and serving the set of files based on a request from the client.
